(19) United States
(12) Patent Application Publication
(10) Pub. No.: US 2021/0046801 A1
(43) Pub. Date: Feb. 18, 2021

(54) TARGETED CABIN THERMAL COMFORT

(71) Applicant: GM Global Technology Operations LLC, Detroit, MI (US)

(72) Inventors: Taeyoung Han, Bloomfield Hills, MI (US); Shailendra Kaushik, Novi, MI (US); Bahram Khalighi, Birmingham, MI (US); Paul E. Krajewski, Troy, MI (US)

(21) Appl. No.: 16/539,651

(22) Filed: Aug. 13, 2019

(51) Int. Cl. B60H 1/00; F04B 45/04; F04B 45/047

(52) U.S. Cl. CPC B60H 1/00885; B60H 1/00285; F04B 45/047; F04B 45/043; B60H 1/00478

(57) ABSTRACT

A thermal comfort device comprises a pair of selectively contractable piezo-electric diaphragms and a body sandwiched between the pair of diaphragms, the body defines a cavity and an opening, wherein, the piezo-electric diaphragms are adapted to be selectively contracted to flex outward, drawing air into the cavity, and to flex inward, forcing air out of the cavity, each of the piezo-electric diaphragms adapted to be selectively controlled by varying the voltage and the frequency, wherein the velocity of the air being forced outward from the cavity is selectively variable, and a thermo-electric device adapted to thermally condition air forced outward from the cavity by one of heating and cooling the air forced outward from the cavity, wherein the thermo-electric device is positioned at one of within the cavity and outside the cavity aligned with the opening.

### INTRODUCTION

The present disclosure relates to targeted thermal comfort for the interior cabin of an automobile. In an automobile, the heating, ventilation and cooling (HVAC) system is typically a centralized system meant to provide climate control for the interior cabin of the automobile homogenously. To provide directable heated or cooled air within the interior cabin of the automobile, vents can be positioned within the vehicle will louvered openings that allow the occupant of the vehicle to direct the flow of heated or cooled air.

In this arrangement, ductwork is necessary to route heated or cooled air from the centralized HVAC system to the vent. These ducts occupy a large amount of space within the automobile. In addition, the structure of the automobile makes it impractical to provide such vents in locations where targeted air flow may be desired.

Thus, while current HVAC systems achieve their intended purpose, there is a need for a new and improved thermal comfort device and targeted thermal comfort system that allows airflow of ambient air to be directed to specific location within the interior of an automobile, and allows such air flows to be heated or cooled independently of the centralized HVAC system within an automobile.

### SUMMARY

According to several aspects of the present disclosure, a thermal comfort device comprises a pair of selectively contractable diaphragms, and a body sandwiched between the pair of diaphragms, the body defining a cavity and an opening, wherein, the diaphragms are adapted to be selectively contracted to flex outward, drawing air into the cavity through the opening, and to flex inward, forcing air out of the cavity through the opening.

According to another aspect, each of the pair of selectively contractable diaphragms is a piezo-electric diaphragm.

According to another aspect, each of the piezo-electric diaphragms are adapted to be selectively controlled by varying the voltage and frequency, wherein the velocity of the air being forced outward from the cavity is selectively variable.

According to another aspect, each of the piezo-electric diaphragms is adapted to operate at a voltage between approximately 50 volts and 200 volts, and at a frequency between approximately 100 hertz and 800 hertz.

According to another aspect, the thermal comfort device further includes a thermo-electric device adapted to thermally condition air that is being forced outward from the cavity.

According to another aspect, the thermo-electric device is adapted to thermally condition air forced outward from the cavity by one of heating the air forced outward from the cavity and cooling the air forced outward from the cavity.

According to another aspect, the thermo-electric device is positioned within the cavity, the thermo-electric device adapted to thermally condition air that is drawn into the cavity before the air is forced outward from the cavity.

According to another aspect, the body is formed of a conductive material adapted to conduct heat from the thermo-electric device.

According to another aspect, the thermal comfort device further includes fins extending from sides of the body adapted to dissipate heat from the body.

According to another aspect, the thermo-electric device is positioned in alignment with the opening, further wherein air that is forced outward from the cavity flows through the thermo-electric device and the thermo-electric device is adapted to thermally condition air that is forced outward from the cavity.

According to several aspects of the present disclosure, a targeted thermal comfort system for the interior cabin of an automobile comprises a plurality of thermal comfort devices located within the interior cabin of the automobile to provide focused air flow to specific areas within the interior cabin of the automobile, each thermal comfort device including a pair of selectively contractable diaphragms, and a body sandwiched between the pair of diaphragms, the body defining a cavity and an opening, wherein, the diaphragms are adapted to be selectively contracted to flex outward, drawing air into the cavity through the opening, and to flex inward, forcing air out of the cavity through the opening, the opening adapted to direct air forced outward from the cavity to a specific area within the interior cabin of the automobile.

According to another aspect, each of the pair of selectively contractable diaphragms within each thermal comfort device is a piezo-electric diaphragm.

According to another aspect, the piezo-electric diaphragms of each thermal comfort device are adapted to be independently selectively controlled by varying the voltage and frequency, wherein the velocity of the air being forced outward from the cavity of each thermal comfort device is independently selectively variable, each of the piezo-electric diaphragms adapted to operate at a voltage between approximately 50 volts and 200 volts, and at a frequency between approximately 100 hertz and 800 hertz.

According to another aspect, each of the thermal comfort devices further includes a thermo-electric device adapted to thermally condition air that is being forced outward from the cavity.

According to another aspect, the thermo-electric device within each thermal comfort device is adapted to thermally condition air forced outward from the cavity of the thermal comfort device by one of heating the air forced outward from the cavity and cooling the air forced outward from the cavity.

According to another aspect, the thermo-electric device within each thermal comfort device is positioned within the cavity, the thermo-electric device adapted to thermally condition air that is drawn into the cavity before the air is forced outward from the cavity.

According to another aspect, the body of each thermal comfort device is formed of a conductive material adapted to conduct heat from the thermo-electric device therein.

According to another aspect, the body of each thermal comfort device further includes fins extending from sides of the body adapted to dissipate heat from the body.

According to another aspect, the thermo-electric device is positioned in alignment with the opening, further wherein air that is forced outward from the cavity flows through the thermo-electric device and the thermo-electric device is adapted to thermally condition air that is forced outward from the cavity.

According to several aspects of the present disclosure, a thermal comfort device comprises a pair of selectively contractable piezo-electric diaphragms, a body sandwiched between the pair of diaphragms, the body defining a cavity and an opening and including fins extending from sides of the body adapted to dissipate heat from the body, the body being formed from a conductive material adapted to conduct heat away from the cavity to the fins, wherein, the piezo-electric diaphragms are adapted to be selectively contracted to flex outward, drawing air into the cavity through the opening, and to flex inward, forcing air out of the cavity through the opening, each of the piezo-electric diaphragms adapted to be selectively controlled by varying the voltage between approximately 50 volts and 200 volts and varying the frequency between approximately 100 hertz and 800 hertz, wherein the velocity of the air being forced outward from the cavity is selectively variable, and a thermo-electric device adapted to thermally condition air forced outward from the cavity by one of heating the air forced outward from the cavity and cooling the air forced outward from the cavity, wherein the thermo-electric device is positioned at one of within the cavity and outside the cavity aligned with the opening.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a perspective view of a thermal comfort device according to an exemplary embodiment;

FIG. 2 is an exploded view of the thermal comfort device shown in FIG. 1;

FIG. 3A is a schematic cross-sectional view of the thermal comfort device shown in FIG. 1, wherein the device is not actuated;

FIG. 3B is a schematic cross-sectional view of the thermal comfort device shown in FIG. 1, wherein the device is actuated and air is being drawn into a cavity within the thermal comfort device;

FIG. 3C is a schematic cross-sectional view of the thermal comfort device shown in FIG. 1, wherein the device is actuated and air is being forced from the cavity within the thermal comfort device through an opening;

FIG. 4A is a top view of the body of a thermal comfort device having a thermo-electric device mounted within the cavity according to an exemplary embodiment;

FIG. 4B is a top view of the body of a thermal comfort device having a thermo-electric device mounted within the cavity according to another exemplary embodiment;

FIG. 5 is a schematic perspective view of the body of a thermal comfort device having a thermo-electric device mounted outside the cavity and aligned with an opening of the body according to an exemplary embodiment; and

FIG. 6 is a schematic view of a targeted thermal comfort system according to an exemplary embodiment.

### DETAILED DESCRIPTION

The following description is merely exemplary in nature and is not intended to limit the present disclosure, application, or uses.

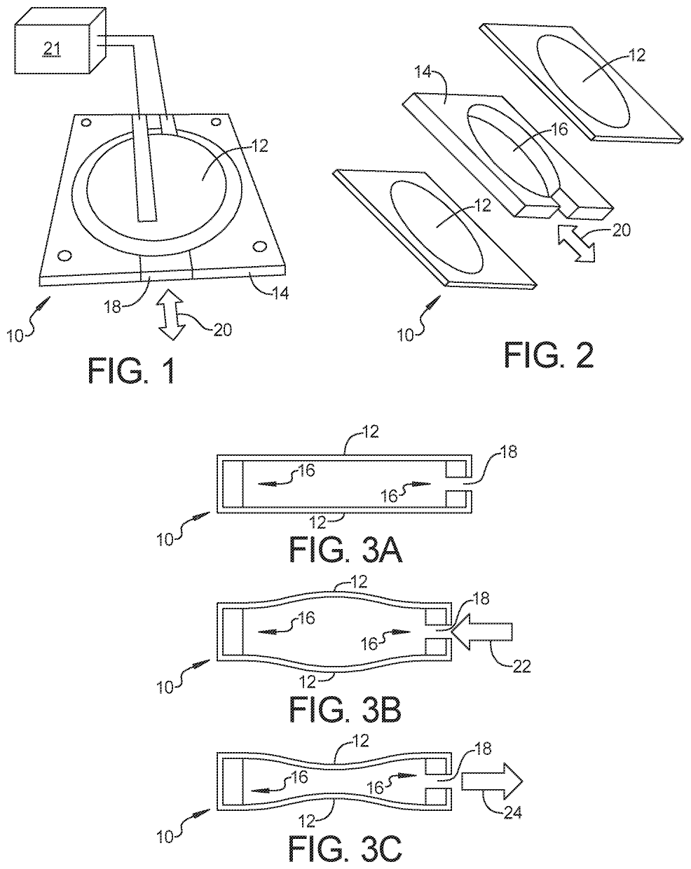

Referring to FIG. 1 and FIG. 2, a thermal comfort device 10 comprises a pair of selectively contractable diaphragms 12 and a body 14 sandwiched between the pair of diaphragms 12. The body 14 defines a cavity 16 therein, and an opening 18 formed within the body 14 allows air to flow into and out of the cavity 16, as shown by arrow 20. In an exemplary embodiment, each of the diaphragms 12 is a piezo-electric diaphragm. When powered from an electric power source 21, the piezo-electric diaphragms 12 will contract in alternating directions.

Referring to FIG. 3A, when not powered, the diaphragms 12 are stationary. When powered, the diaphragms 12 will contract, alternating between contracting inward and contracting outward. When contracting outward, the diaphragms 12 expand the volume of the cavity 16 and draw air into the cavity 16 through the opening 18, as shown by arrow 22 in FIG. 3B. When contracting inward, the diaphragms 12 reduce the volume of the cavity 16 and force air out of the cavity 16 through the opening 18, as shown by arrow 24 in FIG. 3C.

Each of the piezo-electric diaphragms 12 is adapted to be selectively controlled by varying the voltage and frequency. By varying the voltage of the electric current fed to the piezo-electric diaphragms 12, and varying the frequency of the inward and outward contractions, the velocity of the air being forced outward from the cavity 16 is selectively variable. Each of the piezo-electric diaphragms 12 is adapted to operate at a voltage between approximately 50 volts and 200 volts, and at a frequency between approximately 100 hertz and 800 hertz, allowing the thermal comfort device 10 to deliver a flow of air up to 30 m/s. Placed at specific locations within an automobile, the thermal comfort device 10 provides a flow of air to or through a targeted location within the interior of the automobile.

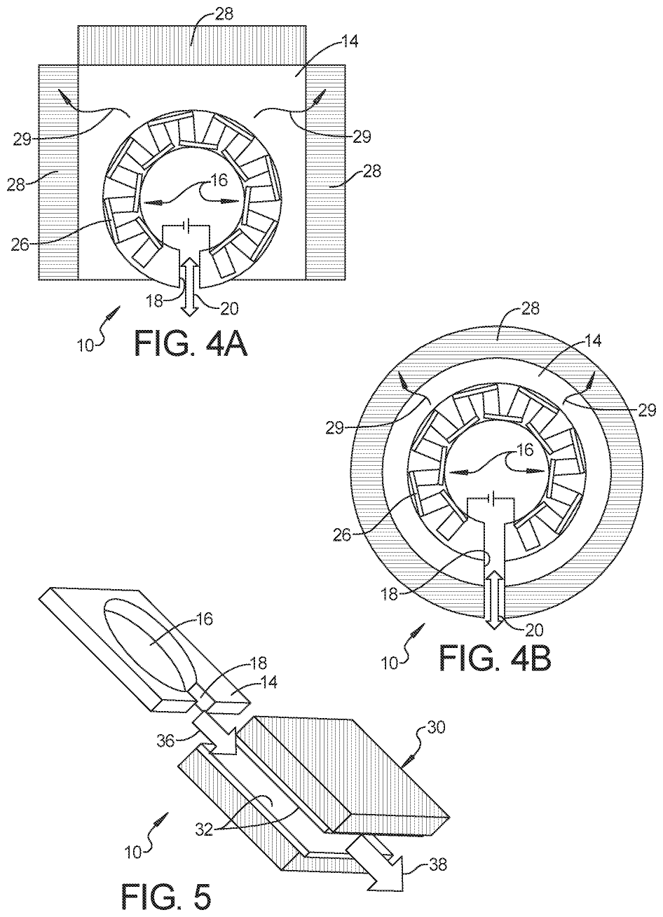

Referring to FIG. 4A and FIG. 4B, in an exemplary embodiment, the thermal comfort device 10 includes a thermo-electric device 26 mounted within the cavity 16. The thermal electric device 26 is adapted to thermally condition air that is being forced outward from the cavity 16. The thermo-electric device 26 is an electrical device which either heats up or cools down when an electric current is provided. If the electrical current provided runs in one direction, the thermo-electric device 26 will heat up. If the electrical current provided is reversed, the thermo-electric device 26 will cool down. The thermo-electric device 26 is adapted to heat up to temperatures significantly higher than normal ambient temperatures within an automobile, and to cool down to temperatures significantly lower than normal ambient temperatures within an automobile. The thermal electric device 26 will either heat or cool the air that is being forced from the cavity 16, depending on the direction of the electric current provided to the thermal electric device 26.

In an exemplary embodiment, the thermo-electric device 26 is positioned within the cavity 16. When the piezo-electric diaphragms 12 contract outward and air is drawn into the cavity 16, the thermo-electric device 26 is either heated or cooled, depending on the direction of the electric current fed to thermo-electric device 26. When the thermo-electric device 26 is heated, the ambient air that is drawn into the cavity 16 is exposed to the thermo-electric device 26 and is heated by absorbing heat from the significantly higher temperature thermo-electric device 26. If the thermo-electric device 26 is cooled, the ambient air that is drawn into the cavity 16 is exposed to the thermo-electric device 26 and is cooled as heat from the ambient air dissipates to the significantly lower temperature thermo-electric device 26. When the piezo-electric diaphragms 12 contract inward, the heated or cooled air is forced outward from the cavity 16.

In another exemplary embodiment, the body 14 of the thermal comfort device 10 is made from a material that is highly conductive. By way of non-limiting examples, the body 14 may be made from a metallic material, such as aluminum or steel, that will readily conduct heat away from the thermo-electric device 26 within the cavity 16, as shown by arrows 29. This allows excess heat from the thermo-electric device 26 to dissipate from the body 14 of thermal comfort device 10.

In another exemplary embodiment, the body 14 of the thermal comfort device 10 includes fins 28 extending laterally from sides of the body 14. The fins 28 will accelerate dissipation of heat from the body 14 of the thermal comfort device 10. Conduction of heat through the body 14 of the thermal comfort device 10 and the fins 28 extending from the sides of the body 14 of the thermal comfort device 10 help to ensure that the thermal comfort device 10 is able to quickly return to ambient temperatures after the thermal comfort device 10 has been used to provide heated or cooled air. By way of non-limiting examples, the thermal comfort device 10 may be square, as shown in FIG. 4A, or round, as shown in FIG. 4B. It should be understood, that the thermal comfort device 10 may be of any suitable shape.

Referring to FIG. 5, in an exemplary embodiment, a thermo-electric device 30 is positioned outside the cavity 16 of the thermal comfort device 10. The thermo-electric device 26 is positioned adjacent the body 14, in alignment with the opening 18. As shown, the thermo-electric device 30 includes two opposing plates 32. When the piezo-electric diaphragms 12 contract outward, ambient air is drawn into the cavity 16, and when the piezo-electric diaphragms 12 contract inward, the ambient air is forced outward from the cavity 16, as shown by arrow 36, and between the plates 32 through the thermo-electric device 30, as shown by arrow 38. The thermo-electric device 30 is either heated or cooled, depending on the direction of the electric current fed to thermo-electric device 30.

When the thermo-electric device 30 is heated, the ambient air that is forced outward through the opening 18 passes between and is exposed to the plates 32 of the thermo-electric device 30 and is heated by absorbing heat from the significantly higher temperature of the plates 32 of the thermo-electric device 30. If the thermo-electric device 30 is cooled, the ambient air that is forced outward through the opening 18 passes between and is exposed to the plates 32 of the thermo-electric device 30 and is cooled as heat from the ambient air dissipates to the significantly lower temperature of the plates 32 of the thermo-electric device 26.

In another exemplary embodiment, the thermo-electric device 30 includes fins 34 extending laterally outward. The fins 34 will accelerate dissipation of heat from the thermo-electric device 30. The fins 34 extending from the thermo-electric device 30 help to ensure that the thermal comfort device 10 is able to quickly return to ambient temperatures after the thermal comfort device 10 has been used to provide heated or cooled air.

Placed at specific locations within the automobile, the thermal comfort device 10 provides a flow of air to or through a targeted location within the interior of the automobile. The thermo-electric device 26, 30 allows the thermal comfort device 10 to provide a flow of heated or cooled air to or through a targeted location within the interior of the automobile. The thermal comfort device 10 targets a specific location within the automobile to provide climate control at that location without the need to route ducts from a centralized HVAC system to that location.

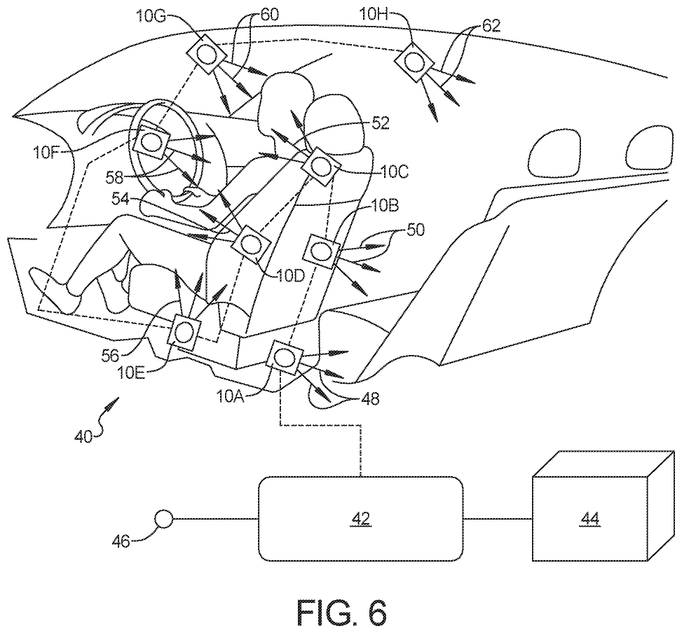

Referring to FIG. 6, a targeted thermal comfort system 40 for the interior cabin of an automobile comprises a plurality of thermal comfort devices 10 located within the interior cabin of the automobile. Each of the thermal comfort devices 10 provides focused air flow to specific areas within the interior cabin of the automobile.

A frequency and power control unit 42 communicates with each of the thermal comfort devices 10. The frequency and power control unit 42 receives power from an electrical power source 44. The frequency and power control unit 42 receives information from an HVAC controller 46 to determine when to power the thermal comfort devices 10, at what frequency to operate the thermal comfort devices 10, and when to actuate the thermo-electrical device 26, 30 within each thermal comfort device 10 to heat or cool the flow of air.

In an exemplary embodiment, the frequency and power control unit 42 is adapted control each thermal comfort device 10 independently of one another. The frequency and power control unit 42 receives input from the HVAC controller 46 and allows an occupant within the automobile control the flow of air from any individual thermal comfort device 10 and to control the temperature of the air flow from each individual thermal comfort device 10.

The targeted thermal comfort system 40 allows the flow of air and temperature of the air provided by thermal comfort devices 10 located at various locations in proximity to the front passenger seat to be different than the flow of air and temperature of the air provided by thermal comfort devices 10 located at various locations in proximity to the rear passenger seat or the driver seat. Each occupant within the automobile can control the climate and air flows that are directed toward them.

Furthermore, the thermal comfort devices 10 that are directed toward a specific passenger location within the automobile can be controlled independently. The occupant sitting in the front passenger seat may desire to have a strong flow of cold air directed toward his feet, and a softer flow of warm air to be directed toward his face.

It should be understood, that the thermal comfort devices 10 can be located anywhere within the interior cabin of the automobile. Referring to FIG. 6, by way of non-limiting examples, a thermal comfort device 10A is positioned on the back of the driver's seat and adapted to direct a flow of air to the feet of a passenger sitting directly behind the driver's seat as indicated by arrows 48. A thermal comfort device 10B is mounted on the back of the driver's seat and adapted to direct a flow of air to the body of a passenger sitting directly behind the driver's seat, as indicated by arrows 50. Three thermal comfort devices 10C, 10D, 10E are located within or in proximity to the driver's seat and adapted to direct a flow of air to the driver's head, body and legs, as indicated by arrows 52, 54 and 56 respectively. A thermal comfort device 10F is mounted on the steering wheel and adapted to direct air flow to the body of the driver, as indicated by arrows 58, and a thermal comfort device 10G is mounted on the headliner and adapted to direct a flow of air to the face of the driver, as indicated by arrows 60. Finally, a thermal comfort device 10H is mounted centrally to the headliner of the automobile and adapted to direct a flow of air to the faces of the passengers in the rear seat, as indicated by arrows 62.

A thermal comfort device 10 and a targeted thermal comfort system 40 of the present disclosure offer the advantage of providing a flow of ambient air to be directed to specific location within the interior of an automobile, and allowing the flow of air to be heated or cooled independently of a centralized HVAC system within an automobile.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A thermal comfort device, comprising:
a pair of selectively contractable diaphragms; and
a body sandwiched between the pair of diaphragms, the body defining a cavity and an opening;
wherein, the diaphragms are adapted to be selectively contracted to flex outward, drawing air into the cavity through the opening, and to flex inward, forcing air out of the cavity through the opening.

2. The thermal comfort device of claim 1, wherein each of the pair of selectively contractable diaphragms is a piezo-electric diaphragm.

3. The thermal comfort device of claim 2, wherein each of the piezo-electric diaphragms are adapted to be selectively controlled by varying the voltage and frequency, wherein the velocity of the air being forced outward from the cavity is selectively variable.

4. The thermal comfort device of claim 3, wherein each of the piezo-electric diaphragms is adapted to operate at a voltage between approximately 50 volts and 200 volts, and at a frequency between approximately 100 hertz and 800 hertz.

5. The thermal comfort device of claim 1, further including a thermo-electric device adapted to thermally condition air that is being forced outward from the cavity.

6. The thermal comfort device of claim 5, wherein the thermo-electric device is adapted to thermally condition air forced outward from the cavity by one of heating the air forced outward from the cavity and cooling the air forced outward from the cavity.

7. The thermal comfort device of claim 6, wherein the thermo-electric device is positioned within the cavity, the thermo-electric device adapted to thermally condition air that is drawn into the cavity before the air is forced outward from the cavity.

8. The thermal comfort device of claim 7, wherein the body is formed of a conductive material adapted to conduct heat from the thermo-electric device.

9. The thermal comfort device of claim 8, further including fins extending from sides of the body adapted to dissipate heat from the body.

10. The thermal comfort device of claim 6, wherein the thermo-electric device is positioned in alignment with the opening, further wherein air that is forced outward from the cavity flows through the thermo-electric device and the thermo-electric device is adapted to thermally condition air that is forced outward from the cavity.

11. A targeted thermal comfort system for the interior cabin of an automobile, comprising:
a plurality of thermal comfort devices located within the interior cabin of the automobile to provide focused air flow to specific areas within the interior cabin of the automobile, each thermal comfort device including a pair of selectively contractable diaphragms, and a body sandwiched between the pair of diaphragms, the body defining a cavity and an opening, wherein, the diaphragms are adapted to be selectively contracted to flex outward, drawing air into the cavity through the opening, and to flex inward, forcing air out of the cavity through the opening, the opening adapted to direct air forced outward from the cavity to a specific area within the interior cabin of the automobile.

12. The targeted thermal comfort system of claim 11, wherein each of the pair of selectively contractable diaphragms within each thermal comfort device is a piezo-electric diaphragm.

13. The targeted thermal comfort system of claim 12, wherein the piezo-electric diaphragms of each thermal comfort device are adapted to be independently selectively controlled by varying the voltage and frequency, wherein the velocity of the air being forced outward from the cavity of each thermal comfort device is independently selectively variable, each of the piezo-electric diaphragms adapted to operate at a voltage between approximately 50 volts and 200 volts, and at a frequency between approximately 100 hertz and 800 hertz.

14. The targeted thermal comfort system of claim 11, wherein each of the thermal comfort devices further includes a thermo-electric device adapted to thermally condition air that is being forced outward from the cavity.

15. The targeted thermal comfort system of claim 14, wherein the thermo-electric device within each thermal comfort device is adapted to thermally condition air forced outward from the cavity of the thermal comfort device by one of heating the air forced outward from the cavity and cooling the air forced outward from the cavity.

16. The targeted thermal comfort system of claim 15, wherein the thermo-electric device within each thermal comfort device is positioned within the cavity, the thermo-electric device adapted to thermally condition air that is drawn into the cavity before the air is forced outward from the cavity.

17. The targeted thermal comfort system of claim 16, wherein the body of each thermal comfort device is formed of a conductive material adapted to conduct heat from the thermo-electric device therein.

18. The targeted thermal comfort system of claim 17, wherein the body of each thermal comfort device further includes fins extending from sides of the body adapted to dissipate heat from the body.

19. The targeted thermal comfort system of claim 15, wherein the thermo-electric device is positioned in alignment with the opening, further wherein air that is forced outward from the cavity flows through the thermo-electric device and the thermo-electric device is adapted to thermally condition air that is forced outward from the cavity.

20. A thermal comfort device, comprising:
a pair of selectively contractable piezo-electric diaphragms;
a body sandwiched between the pair of diaphragms, the body defining a cavity and an opening and including fins extending from sides of the body adapted to dissipate heat from the body, the body being formed from a conductive material adapted to conduct heat away from the cavity to the fins;
wherein, the piezo-electric diaphragms are adapted to be selectively contracted to flex outward, drawing air into the cavity through the opening, and to flex inward, forcing air out of the cavity through the opening, each of the piezo-electric diaphragms adapted to be selectively controlled by varying the voltage between approximately 50 volts and 200 volts and varying the frequency between approximately 100 hertz and 800 hertz, wherein the velocity of the air being forced outward from the cavity is selectively variable; and
a thermo-electric device adapted to thermally condition air forced outward from the cavity by one of heating the air forced outward from the cavity and cooling the air forced outward from the cavity;
wherein the thermo-electric device is positioned at one of within the cavity and outside the cavity aligned with the opening.
